(19) United States
(12) Patent Application Publication
(10) Pub. No.: US 2003/0161622 A1
(43) Pub. Date: Aug. 28, 2003

(54) Mobile telescoping camera mount

(76) Inventor: Robert D. Zantos, Santa Ana, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/327,716

(22) Filed: Dec. 20, 2002

Related U.S. Application Data
(60) Provisional application No. 60/344,729, filed on Dec. 28, 2001.

(51) Int. Cl. F16M 11/02

(52) U.S. Cl. 396/419; 248/177.1; 248/187.1; 248/129

(57) ABSTRACT

The preferred embodiment of the invention comprises a base frame which provides support, a extensible telescoping mast with camera mounts to elevate a video camera to a higher vantage point, an operator control assembly which allows the user to manually aim the video camera which is beyond his reach, and a display for the user to view the output from the video camera. This gives the operator an advantageous vantage point and field of view during sporting events, social functions, photojournalism, crowd control and the study of nature, to name only a few applications. Embodiments of the invention may additionally comprise a camera control module to remotely control the electronic functions of the camera (e.g. zoom) and an optional sunscreen to shield the display from direct sunlight.

### PRIORITY CLAIM

This application claims the benefit of priority under 35 U.S.C. §119(e) of U.S. Provisional Application No. 60/344,729 filed on Dec. 28, 2001, titled MOBILE TELESCOPING CAMERA MOUNT, the entirety of which is incorporated herein by reference.

### FIELD OF THE INVENTION

This invention relates to a mobile telescoping camera mount that elevates a video camera above the height of its user, allowing the user to capture images from a higher vantage point. This mobile telescoping camera mount allows the user to manually aim the video camera. There are many possible applications for this invention, including sporting events, photojournalism, crowd control and the study of nature, to name only a few.

### SUMMARY OF THE INVENTION

The preferred embodiment of the invention comprises a base frame which provides support, a extensible telescoping mast with camera mounts to elevate a video camera or a camera to a higher vantage point, an operator control assembly which allows the user to manually aim the video camera which is beyond his reach, and a display for the user to view the output from the video camera. Embodiments of the invention may additionally comprise a camera control module to remotely control the electronic functions of the camera (e.g. zoom) and an optional sunscreen to shield the display from direct sunlight.

### BRIEF DESCRIPTION OF THE DRAWINGS

FIG. 1 is a perspective view of one embodiment of the telescoping camera mount,

FIG. 2 is a perspective view of the bottom portion of the mobile telescoping camera mount shown in FIG. 1,

FIG. 3 is a perspective view of the top end of the mast of the mobile telescoping camera mount of FIG. 1,

FIG. 4 is a perspective view of the operator control assembly of the mobile telescoping camera mount of FIG. 1,

FIG. 5 is a perspective view illustrating the interaction between the extensible telescoping mast and the operator control system,

FIG. 6 is a perspective view of the bottom end of the extensible telescoping mast,

FIG. 7 is an exploded perspective view of the components mounted at the bottom end of the extensible telescoping mast,

FIG. 8 is a perspective view illustrating the interaction between the tilt pulley and the bottom pulleys, and

FIG. 9 is a perspective view further illustrating the operation of the mobile telescoping camera mount of FIG. 1.

### DETAILED DESCRIPTION OF THE PREFERRED EMBODIMENT

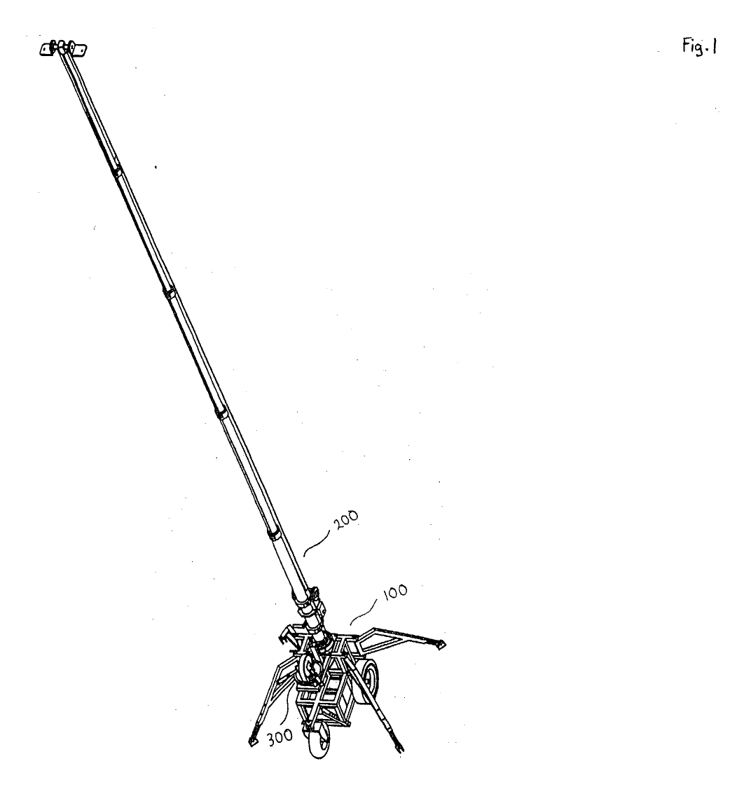

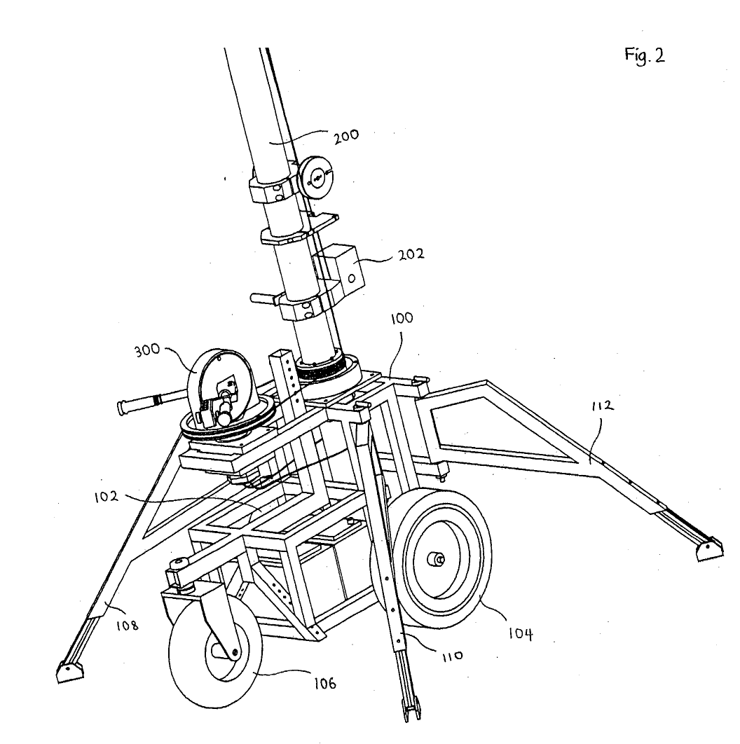

Referring to FIGS. 1 and 2, a base frame (100) supports an extensible telescoping mast (200) having video camera mounts at the top, and the operator control assembly (300). The base frame (100) serves as a platform on which other subparts are mounted.

For mobility the base frame (100) is equipped with wheels (102, 104, 106). Optimally, two fixed wheels (102, 104) are mounted at the opposite front corners of the base frame (100), while a pivoting wheel (106) is mounted in the center at the rear of the base frame (100). This setup (biplane style) maximizes the maneuverability of the base frame (100) with the least number of wheels. Alternatively, in other embodiments of the invention, wheels may be mounted at all four corners of the base frame, with the front set being pivoting and the rear set being fixed (shopping cart style) or vice versa. The latter two setups provide more stability when the base frame is in motion, e.g., when it is wheeled to and from its location of deployment.

For additional stability when deployed, the base frame is equipped with telescoping legs (108, 110, 112). Preferably, there are four telescoping legs with one mounted near each corner of the base frame. The telescoping leg at the front left corner of the base frame (100) is hidden from view in FIG. 2. Optimally, these telescoping legs are infinitely adjustable in length to allow the operator to deploy on irregular terrain to adjust the base to provide a level mount for the mast (100). Preferably, the legs are foldable, to ease transportation. In the preferred embodiment, all four telescoping legs swing out from folded positions along axes perpendicular to the ground. To maximize stability when deployed at least the front telescoping legs may be positioned such that they extend over the front wheels. Locking pins or the like fix the positions, while wing nuts or the like lock the lengths of the telescoping legs when deployed.

The extensible telescoping mast (200) is mounted vertically on the base frame (100), perpendicularly to the base frame (100) and to the ground. The end of the mast (200) attached to the base frame (100) is referred to as the bottom end, while the other end is referred to as the top end. The bottom end of the mast (200) is mounted to the base frame (100) in a manner which allows the mast to be rotated along its center axis. See infra regarding panning.

A cable winch (202) allows the user to extend or to collapse the extensible telescoping mast (200). Preferably the winch (202) has a locking mechanism that allows the user to select a height up to the maximum extended length of the mast (200). Extensible telescoping masts are well known in the prior art and a lengthy description is not required here.

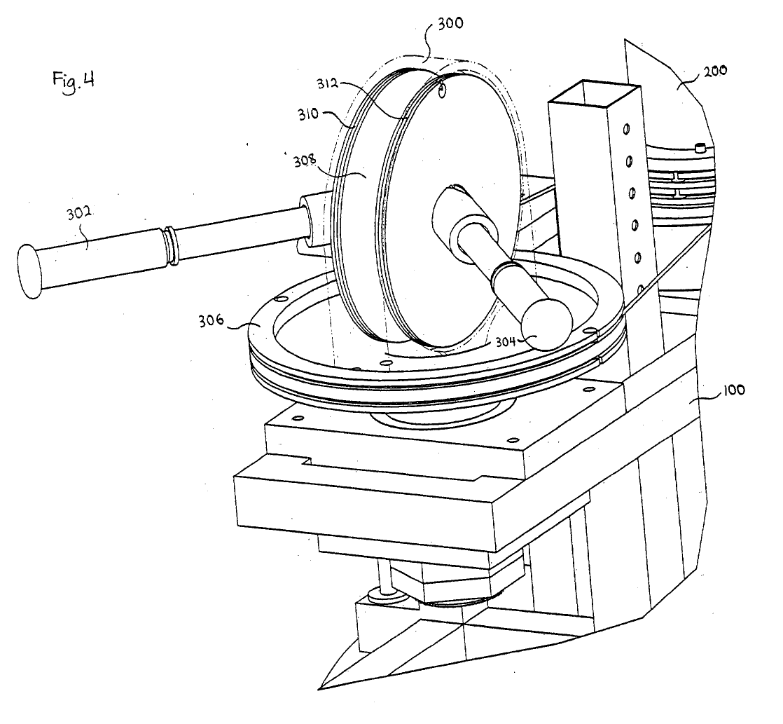

The operator control assembly (300) is also mounted to the base frame (100), aft of the telescoping mast (200). It is described in further detail below in FIG. 4.

A display, preferably a lightweight LCD screen (not shown) is advantageously mounted on the base frame (100) to allow the user to view the output from the camera or cameras mounted on the camera mounts at the top end of the telescoping mast (200). Ideally the display is mounted just aft of the telescoping mast and forwards of the operator control assembly (300). Also ideally the display mount is adjustable height-wise to allow the most ergonomic viewing position while the user is articulating the operator control assembly.

An optional sunscreen, the size of which is customizable, may be mounted to the base frame at a height above that of the display, so that the image on the display is not washed out when viewed under sunny conditions. The sunscreen is preferably large enough so that multiple viewers may view the display together.

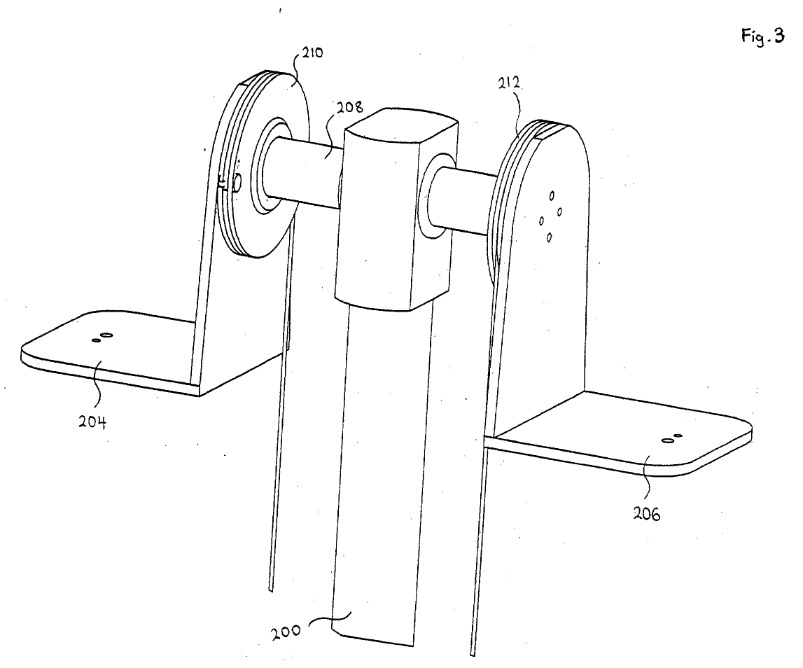

Camera mounts (204, 206) are provided at the top end of the mast (200) as shown in FIG. 3. In the preferred embodiment, two L-shaped camera mounts (204, 206) are attached to both ends of a top horizontal shaft (208) extending through the top end of the mast (200) along the mast's diameter. A pulley is mounted on the top horizontal shaft (208) next to each camera mount, with the top horizontal shaft (208) extending through the center of each pulley. The pulley thus mounted between the left camera mount (204) and the mast (200) is referred to as the left top pulley (210), while the pulley thus mounted between the right camera mount (206) and the mast (200) is referred to as the right top pulley (212). The top pulleys (210, 212) are of the same size. Both camera mounts (204, 206) and both top pulleys (210, 212) are fixed in relation to each other and the top horizontal shaft (208), e.g., the camera mounts (204, 206) and the top pulleys (210, 212) do not rotate freely around the shaft. The top horizontal shaft (208) does rotate freely in relation to the top end of the telescoping mast (200). In the preferred embodiment both camera mounts (204, 206) are tilted simultaneously.

The left and right top pulleys (210, 212) are used to control the tilting of the camera mounts (204, 206) in an upwards or downwards direction. See infra regarding tilting. Advantageously, each camera mount is sized such that the camera may be mounted with the camera's center of gravity at or just below the center of the top pulley attached to the camera mount. In the preferred embodiment two identical cameras can be mounted, one to keep track of the wide angle view and the other zoomed in on the center of the action. We can thus think of the cameras as sharing a common center of gravity. If the cameras' center of gravity is above the center of the top pulleys, the weight of the cameras tends to exaggerate any tilting motion of the camera mounts. Conversely, if the cameras' center of gravity is below the center of the top pulleys, the weight of the cameras tends to hinder any tilting motion of the camera mounts, exerting a force due to gravity to return the tilt angle of the cameras to a neutral position determined by the cameras' center of gravity. For precise control the latter is preferred. For cameras positioned to record activities at or near ground level, a center of gravity forwards (the direction the cameras are pointing) of the center of the top pulleys is desired. An arm extending backwards (not shown) may be mounted on either camera mount as a counter balance. To summarize the cameras on the preferred embodiment are mounted with their common center of gravity just forwards of and below the centers of the top pulleys.

The operator control assembly (300) best shown in FIG. 4 enables the user to remotely control the panning and the tilting of the camera mounts via handlebars (302, 304) extending from this operator control assembly (300). There are two circular pulleys in the operator control assembly (300). The pan pulley (306) is mounted with its plane of rotation parallel to the base frame (100), and with its axis of rotation parallel to the axis of rotation of the telescoping mast (200). The tilt pulley (308) is formed by a left tilt pulley disk (310) and a right tilt pulley disk (312), both of which are mounted at right angles to the pan pulley (306). Thus the tilt pulley (308) is mounted with its plane of rotation perpendicular to the ground.

Handlebars (302, 304) extending from the operator control assembly allow the user to rotate the pan pulley (306) and the tilt pulley (308), either individually or simultaneously. Thus control of the pan angle can be maintained while tilting the camera mounts, and likewise control of the tilt angle can be maintained while panning the camera mounts. This precise degree of control is a significant advantage of the preferred embodiments of the present invention. The user controls the rotation of the pan pulley (306) by turning the handlebars (302, 304) in a motion similar to steering a motorcycle. The user controls the rotation of the tilt pulley (308) via pushing or pulling the handlebars (302, 304), in a motion similar to rowing a boat.

A camera control module (not shown) is advantageously mounted on either handlebar of the operator control assembly (300). This camera control module is provided with buttons to remotely effectuate camera controls such as zoom, record start and stop, slow motion, etc.. As is well known in the art, this camera control module can be programmed with the camera maker” proprietary camera control codes, which is sent up to the camera via a signal cable (not shown).

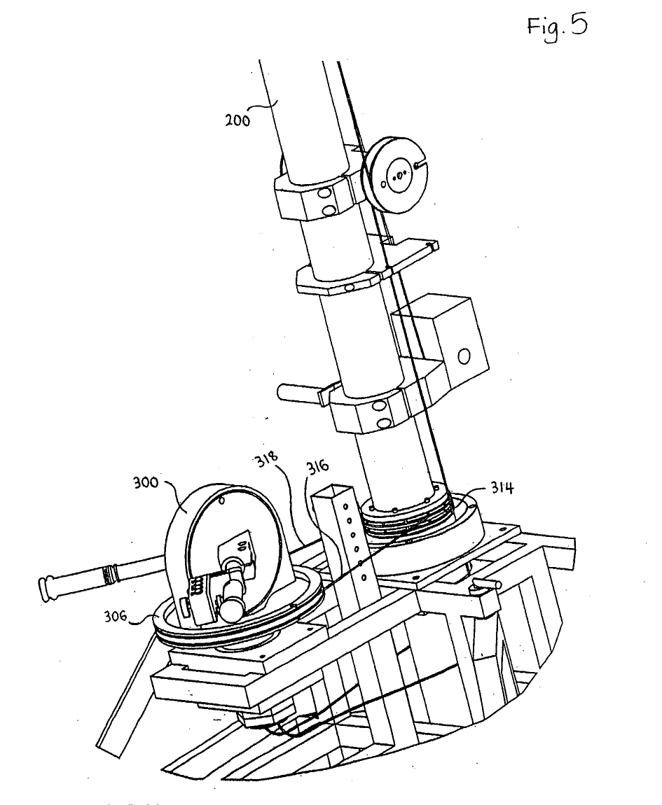

The interaction between the extensible telescoping mast (200) and the operator control assembly (300) is best shown in FIG. 5. A concentric pulley (314) is fixed concentrically around the bottom end of the mast (200), and thus they share the same axis of rotation. The concentric pulley (314) rotates with the telescoping mast (200). In the preferred embodiment two cables (316, 318) running between the pan pulley (306) and the concentric pulley (314) allow rotation of the pan pulley (306) to rotate the concentric pulley (314). The first cable (316) is attached such that when the pan pulley (306) is rotated clockwise (from a top view), the first cable (316) pulls the concentric pulley (314) to rotate clockwise too. Likewise, the second cable (318) is attached such that when the pan pulley (306) is rotated counter-clockwise (from a top view), the second cable (318) pulls the concentric pulley (314) to rotate counter-clockwise. Alternatively a belt wrapped around both pulleys, similar to tank treads, may be used to link the rotation of the two pulleys.

The sizes of the pan pulley (306) and the concentric pulley (314) may be customized to adjust the ratio of rotation. Currently the diameter of the pan pulley (306) is twice that of the concentric pulley (314), such that a 1:2 ratio of rotation is achieved, e.g., the user only needs to rotate the pan pulley (via the handlebars) 10 degrees to pan the camera mounts by 20 degrees. This reduces the range of motion of the user while still allowing him to precisely pan the camera mounts.

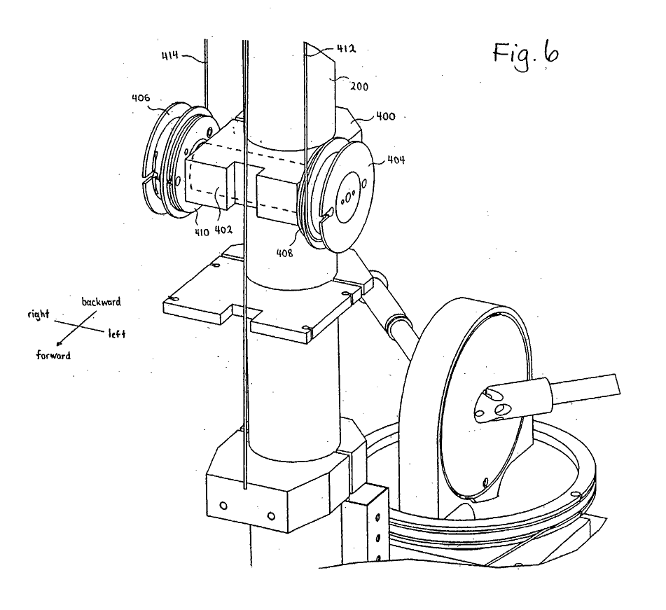

Referring to FIG. 6, a bracket (400) protruding forwards (from the user) is mounted on the bottom end of the mast (200). A bottom horizontal shaft (402) extends through this bracket (400) along an axis parallel to the diameter of the mast (200). Attached on either end of the bottom horizontal shaft (406) are the left take up reel (404) and the right take up reel (406), respectively. The left bottom pulley (408) is sandwiched between the left take up reel (404) and the bottom end of the mast (200), while the right bottom pulley (410) is sandwiched between the right take up reel (406) and the bottom end of the mast (200). The bottom pulleys (408, 410) are of the same size. The bottom pulleys (408, 410) are fixed in relation to each other and to the bottom horizontal shaft (402) such that they all rotate together. The take up reels (404, 406) are free to rotate around the bottom horizontal shaft (402). A cable runs from each take up reel up to its corresponding top pulley at the top end of the mast. These two cables are the third cable (412) and the fourth cable (414). The third cable (412) runs from the left take up reel (404) up to the left top pulley, while the fourth cable (414) runs from the right take up reel (406) up to the right top pulley.

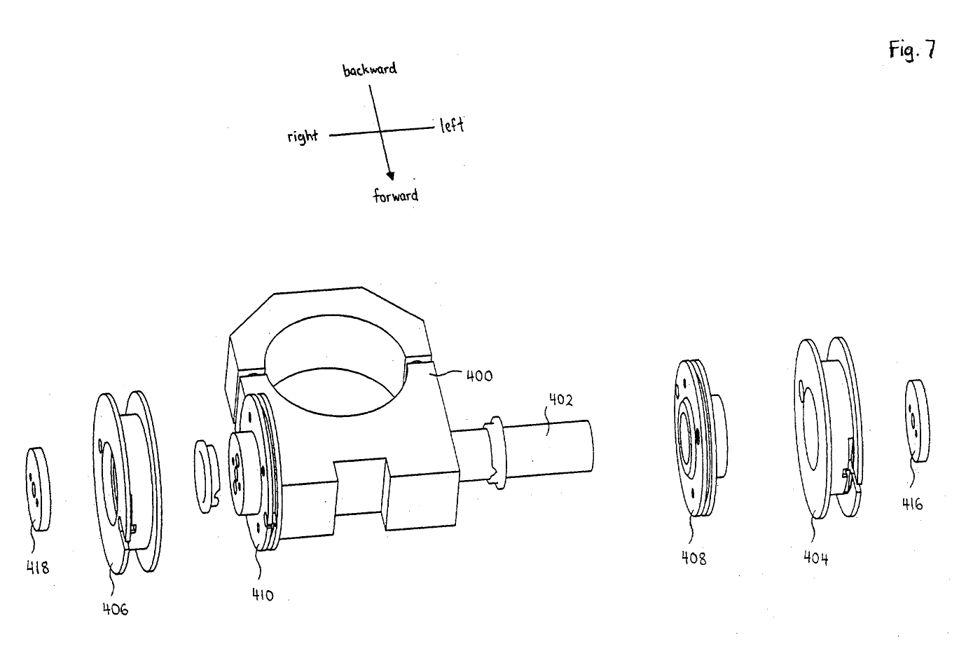

FIG. 7 shows a disassembled view of the components mounted on the bracket (400) at the bottom end of the mast. The bottom horizontal shaft (402), the bottom pulleys (408, 410) and the take up reels (404, 406) are all shown. In addition, two clutch caps (416, 418) are shown. Each take up reel may be engaged to its neighboring bottom pulley by using the clutch cap to tighten the take up reel against its neighboring bottom pulley, so that the take up reel will rotate with its neighboring bottom pulley.

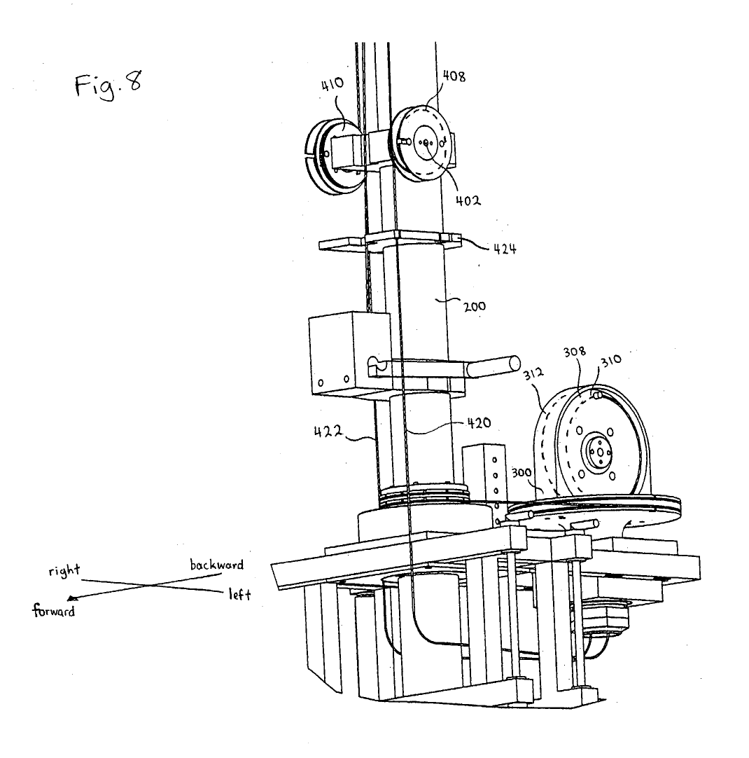

Referring to FIG. 8, the interaction between the tilt pulley (308) and the bottom pulleys (408, 410) is as follows: The tilt pulley (308) in the operator control assembly (300) controls the rotation of the bottom horizontal shaft (402), on which the bottom pulleys (408, 410) are mounted. A fifth cable (420), wrapped around the left tilt pulley disk (310) of the tilt pulley (308) in one direction, runs to the left bottom pulley (408), while a sixth cable (422), wrapped around the right tilt pulley disk (312) in the opposite direction, runs to the right bottom pulley (410). Both cables (420, 422) run through a cable guide plate (424) mounted on the bottom end of the mast (200). Both cables (420, 422) are shielded in flexible jackets running from the cable guide plate (424) to the operator control assembly (300). The cables (420, 422) running from the tilt pulley (308) to the bottom pulleys (408, 410) are set up so that any rotation of the tilt pulley (308) causes rotation of the bottom pulleys (408, 410) and the bottom horizontal shaft (402) in the same direction. For users desiring inverted tilt control of the camera mounts, these two cables (420, 422) may be routed through alternate cable guide holes in the cable guide plate (424) so that any rotation of the tilt pulley (308) causes rotation of the bottom pulleys (408, 410) and the bottom horizontal shaft (402) in the opposite direction.

The sizes of the tilt pulley (308) and the bottom pulleys (408, 410) may be customized to adjust the ratio of rotation. Currently the diameter of the tilt pulley (308) is twice that of the bottom pulleys (408, 410) such that a 1:2 ratio of rotation is achieved. The rate of rotation between the tilt pulley and the bottom pulleys should be equal to the rate of rotation between the pan pulley and the concentric pulley, so that the rate of rotation for both panning and tilting the camera mounts are the same. This is the most intuitive setup. However, a user may individually adjust these two ratios if such need arises.

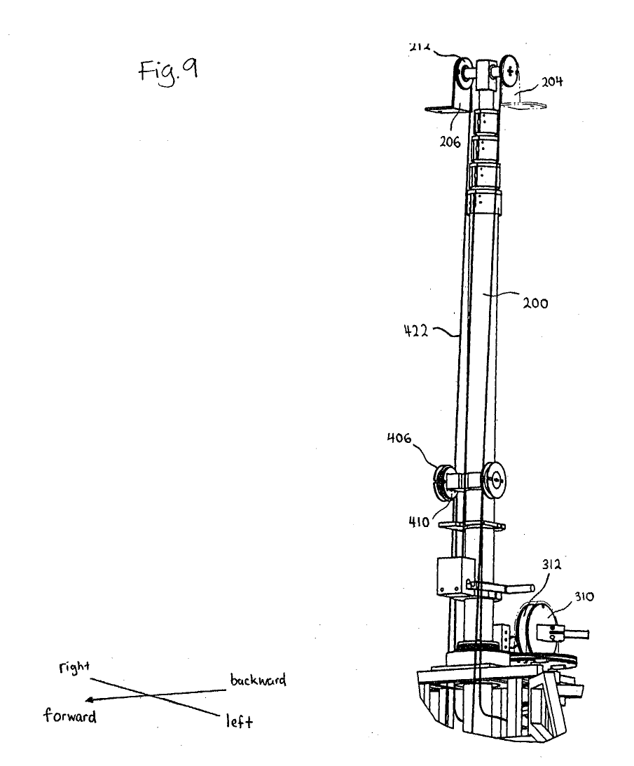

FIG. 9 illustrates the chain of interactions between the right tilt pulley disk (312), the right bottom pulley (410), the right take up reel (406), the right top pulley (212) and the right camera mount (206). As mentioned above under FIG. 8, rotation of the right tilt pulley disk (312) causes rotation of the right bottom pulley (410) according to a determined ratio of rotation. The right take up reel (406) may be engaged to the neighboring right bottom pulley (410) via a clutch mechanism as described under FIG. 7. Rotation of the right bottom pulley (410) causes the cable (422) from the right take up reel (406) to pull on the right top pulley (212), rotating the right top pulley (212) in the same direction as the right bottom pulley (410). The right camera mount (206) is attached to the right top pulley (212). Recall that the above description applies equally to the left tilt pulley disk and the bottom pulley, take up reel, top pulley and camera mount on the left side of the mast. Thus rotation of the tilt pulley, formed by the tilt pulley disks (310, 312) controls the tilting of the camera mounts (204, 206).

Schematically, a take up reel connects its corresponding top and bottom pulleys on the same side of the extensible telescoping mast. This serves three functions. Since the height of the mast is adjustable, each take up reel allows the cable running up to its corresponding top pulley to be adjustable. When the telescoping mast is fully collapsed, each take up reel may be fully disengaged from its corresponding bottom pulley to serve as a winch to collect the excess length in the cable running up to its corresponding top pulley. Lastly, the user may adjust the default tilt angle of the camera mounts via the clutch mechanisms between each take up reel and its neighboring bottom pulley.

The preferred embodiments of this invention provide several significant advantages First, the user can stay put while aiming the camera. Second, the ratios of rotation in both the pan and tilt directions of the camera mounts are customizable. Third, as mentioned, the default tilt angle of the camera mounts is adjustable. Fourth, opposed pulling cables control rotation of the camera mounts in both horizontal and vertical planes, allowing precise control.

It will be evident to those skilled in the art that the invention is not limited to the details of the foregoing illustrated embodiments and that the present invention may be embodied in other specific forms without departing from the spirit or essential attributed thereof. The foregoing description of the present embodiments is therefore to be considered in all respects as illustrative and not restrictive, with the scope of the invention being delineated by the appended claims and their equivalents.

What is claimed is:

1. A mobile camera mount for a camera, comprising:
a base;
an extensible mast coupled to said base;
a mount for said camera located substantially at the top of said extensible mast;
an operator control assembly coupled to said extensible mast and said camera mount, said assembly adapted to rotate said extensible mast and tilt said camera mount to remotely control said camera; and
a display adapted to be coupled to said camera to display images captured by said camera.
